(19) United States
(12) Patent Application Publication
(10) Pub. No.: US 2007/0152099 A1
(43) Pub. Date: Jul. 5, 2007

(54) Onboard modular optronic system

(76) Inventor: Dominique Moreau, Issy-Les-Moulineaux (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/582,632

(22) PCT Filed: Dec. 9, 2004
(86) PCT No.: PCT/EP04/53379

§ 371 Date: Jun. 12, 2006

(30) Foreign Application Priority Data
Dec. 12, 2003 (FR) 03 14600

(51) Int. Cl. B64C 39/02; B64D 47/00

(52) U.S. Cl. 244/117 R

(57) ABSTRACT

The present invention relates to a modular optronics system onboard a carrier, such as a combat aircraft, a helicopter or a drone. The system as claimed in the invention comprises at least one optronics element having a target line that can be addressed in a given space, and comprising a mechanical structure designed to be the interface with the carrier and a target line orientation and stabilization mechanism. According to the invention, the mechanical structure comprises a module forming a section with three interfaces, including said interface with the carrier and two lateral interfaces that can receive a lateral module. The optronics elements and the target line orientation and stabilization mechanism are directly incorporated in the module forming a section.

### CROSS-REFERENCE TO RELATED APPLICATIONS

The present Application is based on International Application No. PCT/EP2004/053379, filed on Dec. 9, 2004, which in turn corresponds to FR 03/14600 filed on Dec. 12, 2003, and priority is hereby claimed under 35 USC §119 based on these applications. Each of these applications are hereby incorporated by reference in their entirety into the present application.

### TECHNICAL FIELD

The present invention relates to a modular optronics system onboard a carrier, such as a combat aircraft, a helicopter or a drone.

### BACKGROUND OF THE INVENTION

Most airborne optronics systems intended for observation, reconnaissance and laser designation take the form of a pod with a pointed mobile turret at the front, or of a sphere incorporating all the sensors.

FIGS. 1A and 1B thus respectively represent a pod type system and a sphere type system, according to the prior art. In FIG. 1, the pod 10 comprises a front section 101 equipped with one or more optronics sensors, a laser where appropriate, for example a designating laser, and the target line stabilization and orientation mechanism. It further comprises a central section 102, which contains all the electronics and a rear section 103 containing a thermal conditioning system for all the pod. The pod is fixed to the carrier, directly or via a mast, by means of attachments 104 fixed to the central section. A number of architectures are known for the front section. According to a variant, the assembly comprising sensors, laser and target line stabilization and orientation mechanism is positioned in a gimbal joint that can be rotated about the axis of the pod in order to address the target line in the target space. This variant has the particular drawback of limiting the number of sensors that can be installed and making it very difficult, even impossible, to upgrade the sensors, and in particular the laser, because a change of any one of these elements placed in the gimbal joint will entail redimensioning all the gimbal joint. According to other variants, the laser and/or the optronics sensors are placed in the front section, but outside the gimbal joint. This makes it possible to upgrade the sensors and/or the laser, but increases the length of the front section and its weight, which adversely affects the mechanical stability of the assembly. One advantage of a sphere type onboard system as represented in FIG. 1B (reference 11) compared to a pod type system, is, in particular, that it makes it possible to limit the aero-optical effects associated with the strong turbulences generated in the areas adjacent to the front section of the pod when the carrier is in flight, and which cause optical performance degradations. In practice, the optronic sphere 11 comprises a mechanical structure 111, which can be moved to orient the target line relative bearing-wise, inside which are grouped the assembly comprising the optronics sensors, laser and target line stabilization and orientation mechanism, this compact structure being fixed to the carrier directly or via a frame. A porthole 112 with one or more windows allows the incident and transmitted light flux to pass through. However, this extremely compact architecture, like the one described previously, is fixed, and any change of specifications to a sensor or to the laser will entail a complete redimensioning of the system.

Thus, the equipment known from the prior art must be developed specifically for a given type of carrier, such as a combat aircraft, a helicopter or a drone; there is only very little synergy between them, so their development costs are high, which means that unit costs are high because of the small quantities produced. The costs of ownership, maintenance, stocks of spares and training are also consequently very high. Furthermore, they are difficult to upgrade because of their fixed architecture.

### SUMMARY OF THE INVENTION

The present invention provides a way of overcoming the abovementioned drawbacks by proposing a new, modular onboard optronics system design, which can be adapted to any type of carrier and offers wide-ranging upgradeability potential without a new system having to be redeveloped.

For this, the invention proposes an onboard modular optronics system, comprising at least one optronics element having a target line that can be addressed in a given space, and comprising a mechanical structure designed to be the interface with the carrier and a target line orientation and stabilization mechanism, characterized in that said mechanical structure comprises a module forming a section with three interfaces, including said interface with the carrier and two lateral interfaces that can receive other modules, and in that said optronics element and the target line orientation and stabilization mechanism are directly incorporated in the module forming a section.

The structure equipped with a module forming a section and intended to receive the optomechanical assembly also offers enhancements in terms of mechanical stabilization performance and reduced aero-optical effects.

### BRIEF DESCRIPTION OF THE DRAWINGS

Other advantages and characteristics will become more clearly apparent from reading the description that follows, illustrated by the appended figures which represent:

FIGS. 1A and 1B, two examples of optronics systems according to the prior art (already described);

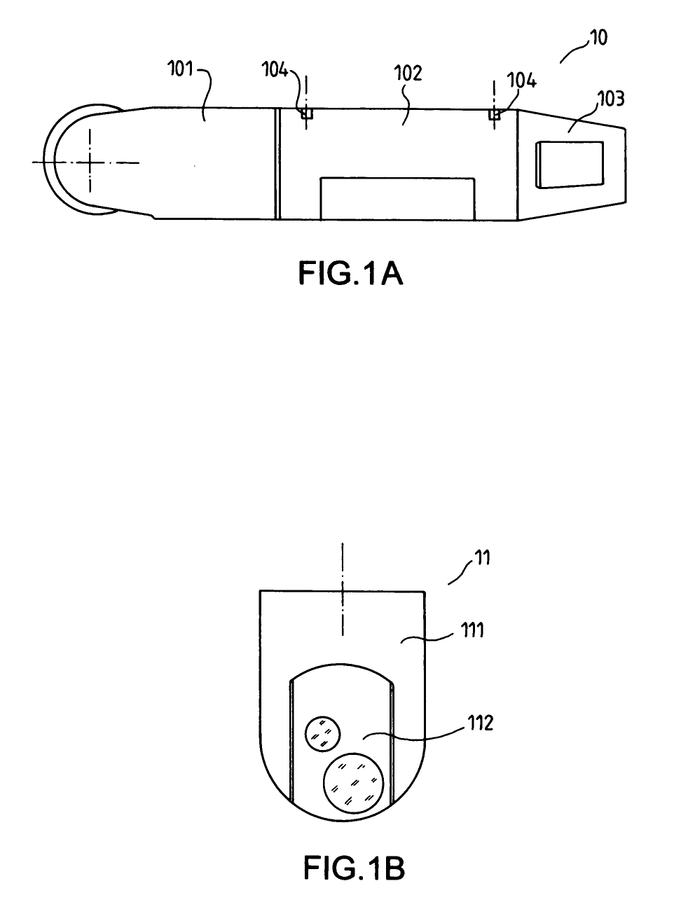

FIGS. 2A and 2B, the diagram according to two views of an example of a modular onboard optronics system according to the invention;

FIGS. 3A and 3B, an example of a modular optronics system according to the invention, respectively mounted on a mast and in a tank;

FIG. 4, an exemplary embodiment of the mechanical structure of said system according to the invention;

FIGS. 5A and 5B, two examples of modular systems according to the invention equipped with their respective module kits;

FIG. 6, a modular onboard system according to the invention for constructing a drone.

In the figures, identical elements are referenced by the same identifiers.

### DETAILED DESCRIPTION

The onboard optronics system according to the invention comprises at least one optronics sensor, for example a camera, defining a target line which needs to be able to be addressed in a given space. It can also comprise a laser, for example for designating a target. It is equipped with a mechanism for stabilizing and orienting the target line or lines defined by the or each sensor, and by the laser where appropriate. According to the invention, the system is modular, comprising in particular a mechanical structure designed to be the interface with the carrier, said mechanical structure comprising a central module forming a section with three interfaces, namely said interface with the carrier and two lateral interfaces that can receive other modules. According to the invention, the target line orientation and stabilization mechanism is directly incorporated in the central module forming a section. The advantages of such a structure are manifold. Since the opto-mechanical components are located in the central module, the aero-optical effects and effects of overheating of the components are significantly reduced. The mechanical stability is better because the system is fixed to the carrier by the part of it that is heaviest and most sensitive to the environments, that is, the central module comprising all the opto-mechanical components. Moreover, the lateral interfaces can be used to fix to the central module forming a section other modules (lateral modules) according to the desired applications, so offering a large number of possible configurations for one and the same central module and making it possible to give the onboard system an aerodynamic shape through the choice of the shapes given to the lateral modules. Finally, as described below, the central module itself can advantageously be designed to be modular, so making it easy to upgrade the system.

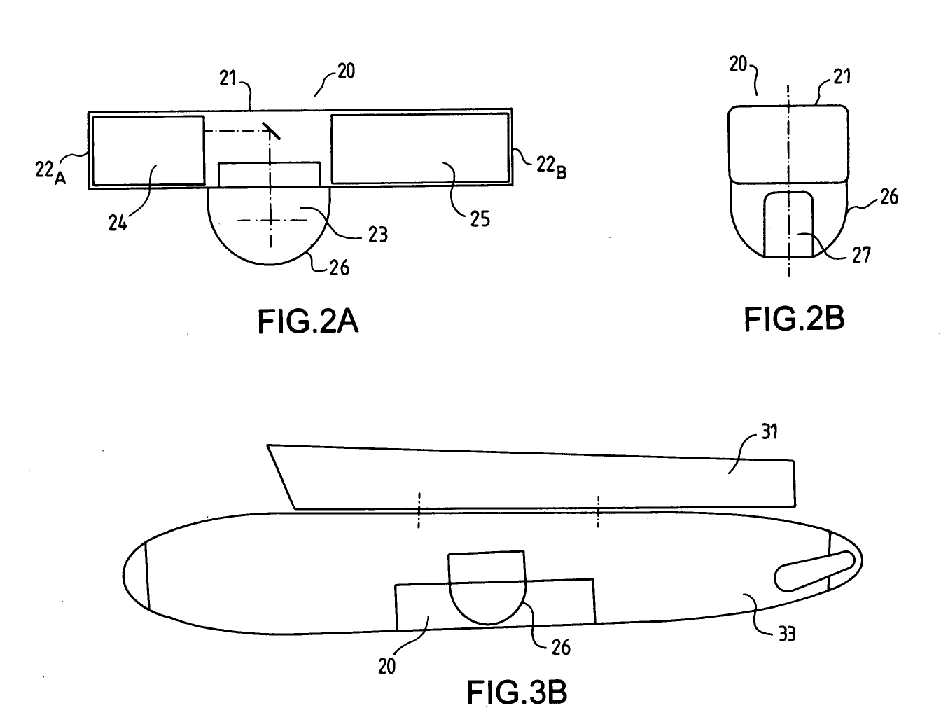

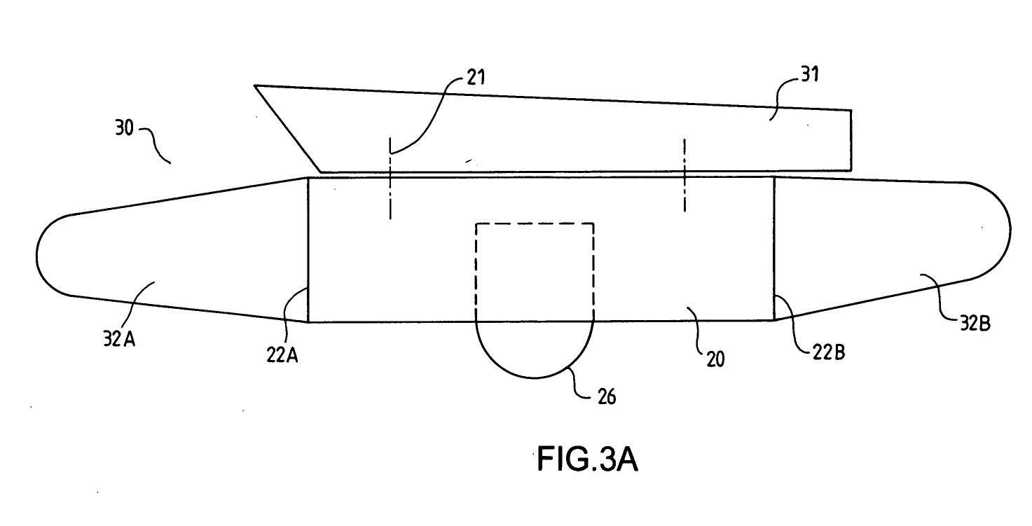

FIGS. 2A and 2B represent diagrammatically views of a module 20 forming a section of the system according to the invention, according to an example. FIG. 3 shows an onboard system 30 according to the invention fixed to a carrier (not represented) via a mast 31.

In this example, the central module 20, equipped with an interface 21 with the carrier and two lateral interfaces 22A and 22B, is designed to receive the optomechanical mechanism 23 for orienting and stabilizing the target line, an optronics assembly 24 with one or more optronics sensors and a laser, where appropriate, an electronic assembly 25 comprising all the processing electronics, and, for example, the power supplies.

The architecture with central module of the optronics system according to the invention makes it possible to address the target line within a relative bearing angle of 2π steradians, which is not possible with a pod type onboard optronics system of the prior art. For this, the central module comprises, for example, a following cowl 26, in the form of a sphere with at least one porthole 27 that is transparent in a spectral band of the optronics system, mounted in such a way to be mobile relative-bearing-wise on the module 20 forming a section and in which is integrated the orientation and stabilization mechanism 23. The following cowl allows target lines to be addressed relative-bearing-wise with an angle of 360° and an accuracy typically measured in milliradians, whereas the orientation and stabilization mechanism allows, for example via a set of mirrors, for fine elevation and relative bearing adjustment (typically 10 to 30 microradians). The target line orientation and stabilization mechanism 23 can be mounted directly in the following cowl or, as will be described in detail below, fixed to a platform suspended in the following cowl for those applications requiring very good stabilization efficiency. Advantageously, the following cowl is retractable, so enabling, when the optronics functions of the system are not in use, the aerodynamics of the onboard system and its radar discretion to be increased.

According to a variant, all the optronics elements are incorporated in the optronics assembly 24, only the orientation and stabilization mechanism being incorporated in the following cowl, which gives the system a great capacity for adaptability since a sensor can be changed inside the optronics assembly 24, without the rest of the central module needing to be redimensioned. The optronics elements comprise at least one sensor, such as a visible spectrum camera, one or more infrared cameras, an active imaging detector, and can include a laser source. In the case of an optronics system designed to operate with several sensors operating in different spectral bands, the following cowl can be equipped with a number of portholes suited to said spectral bands. In some applications, it may be advantageous to provide one or more sensors incorporated in the following cowl, joined to the movements of the orientation and stabilization mechanism 23. Such can be the case, for example, of a camera which requires a very good stabilization and which, because of this, should preferably be positioned as near as possible to the elements maintaining the stabilization of the optronics system, for example a gyroscope of the target line orientation and stabilization mechanism. In all cases, if the optronics system includes a laser, the latter will advantageously be incorporated in the central module, outside the following cowl, so as to allow for intervention on the laser without changing the optomechanical part as a whole. In practice, the laser requires a suitable cooling system which, if incorporated in the following cowl, dictates a specific dimensioning of the latter. Changing the laser for another laser that is more or less powerful that the preceding one, would therefore entail adapting the cooling system and, consequently, redimensioning the following cowl. If the central module is equipped with a suspended plate, the laser source will advantageously be fixed to this plate and accessible, for example, through a hatch to allow for maintenance and/or the changing of the laser.

FIG. 3A illustrates an onboard optronics system 30, fixed to a carrier via the mast 31. The interface 21 with the mast is an electrical and mechanical interface. The system comprises two lateral modules 32A, 32B, respectively fixed by the interfaces 22A, 22B, exemplary embodiments of which are described below. Depending on the type of application, the interfaces 22A, 22B are mechanical (case of a simple fairing), electrical and/or hydraulic to allow for the interfacing with a lateral module constituting, for example, a temperature conditioning module for the system.

FIG. 3B illustrates an onboard optronics system reduced to the central module 20 and incorporated in a fuel tank 33 of a carrier, the tank 33 being itself fixed to the carrier by the mast 31. In this case, since the tank is itself temperature conditioned and designed with an aerodynamic shape, the central module can be incorporated directly in the tank without other lateral modules, its volume (typically 200 liters) remaining low compared to the overall volume of the tank (approximately 2000 liters).

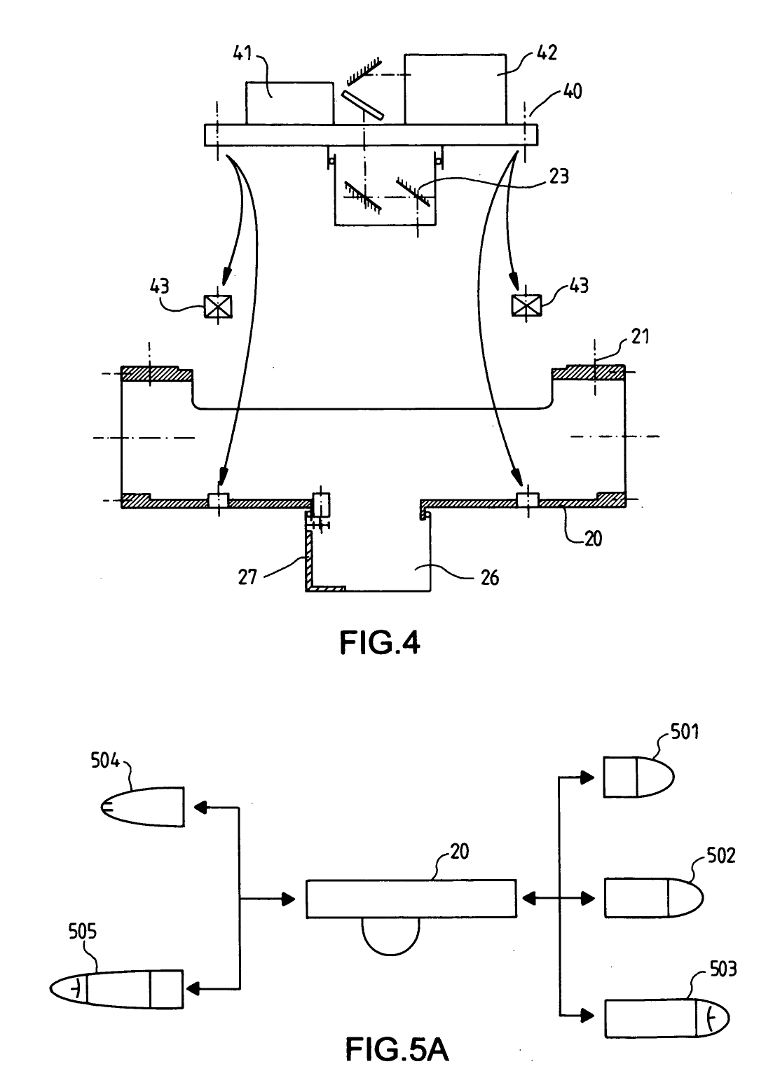

FIG. 4 represents an exemplary embodiment of the mechanical structure of the system according to the invention, comprising a following cowl 26 mounted in such a way as to be mobile bearing-wise on the central module forming a section 20. In this example, the target line stabilization and orientation mechanism 23 is fixed to a platform 40 intended to be suspended in the following cowl. This type of architecture will be preferred for the reconnaissance or target designation type optronics systems, which require very high stabilization efficiency (typically measured in tens of microradians). For other applications, such as, for example, wide field and short range reconnaissance, or systems intended for low altitude drones, for which stabilization efficiency measured in milliradians will be sufficient, the target line stabilization and orientation mechanism can be fixed directly to the following cowl. Thus, in the example of FIG. 4, the platform 40 supports one or more optronics elements 41, 42. It is suspended from the central module 20 by dampers 43.

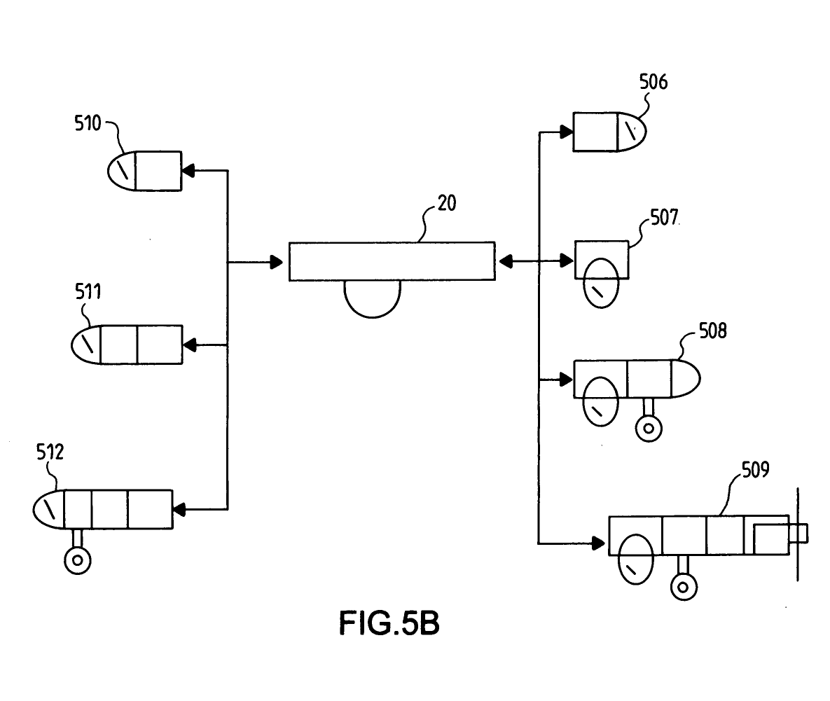

FIGS. 5A and 5B illustrate, according to two examples and in a non-limiting way, the lateral modules that can be connected to the lateral interfaces of a central module 20 forming a section of the system according to the invention. FIG. 5A illustrates the case of an optronics system designed to be mounted onboard an airplane type carrier and FIG. 5B illustrates the case of an optronics system designed to be mounted onboard a drone type carrier.

In FIG. 5A, five examples of lateral modules are diagrammatically represented. The first is a simple fairing (module 501), the only function of which is to optimize the aerodynamic shape of the onboard system. In its minimal version, the onboard system can comprise only two fairings of this type. The second module represented (502) is a module for recording the data acquired by the various sensors of the central module. The third module (503) is a module that includes both the data recording function and the function for transmitting data to the ground. This function is implemented with a radome associated with an antenna. The fourth module (504) diagrammatically represents an environment control module for cooling the system. Thus, if it is decided to change the laser source for a more powerful source that requires cooling of the onboard system, it is possible to add the conditioning system. The fifth module (505) combines the conditioning function with the function for transmitting data to the ground. Of course, this list is not exhaustive. Depending on the applications, different lateral modules can be provided, affording a particular function or a combination of such functions. It is also possible to consider providing an additional optronics sensor in a lateral module.

FIG. 5B represents examples of lateral modules, numbered 506 to 512, intended for a central module 20 for an optronics system onboard a drone. The modules 506, 507, 510 represent modules for transmitting data to the ground with a unidirectional antenna (506, 510) and omnidirectional antenna (507). The module 511 includes, in addition to the function for transmitting data to the ground, the data recording function. The modules 508, 509 and 512 are also equipped with a landing gear for the drone. The modules 508 and 512 include, in addition to the landing gear, respectively, the data transmission and data transmission plus recording functions. The module 509 includes, in addition to the landing gear and data transmission functions, the engine propelling the drone.

The optronics system according to the invention thus allows, through its modular architecture, for the construction of a drone ‘kit’, in which are defined the central module forming a section with the optronics elements and the target line orientation and stabilization mechanism, different lateral modules being able to be connected to the lateral interfaces of the central module according to the configuration selected for the drone, without having to redimension all the opto-mechanical part of the onboard system.

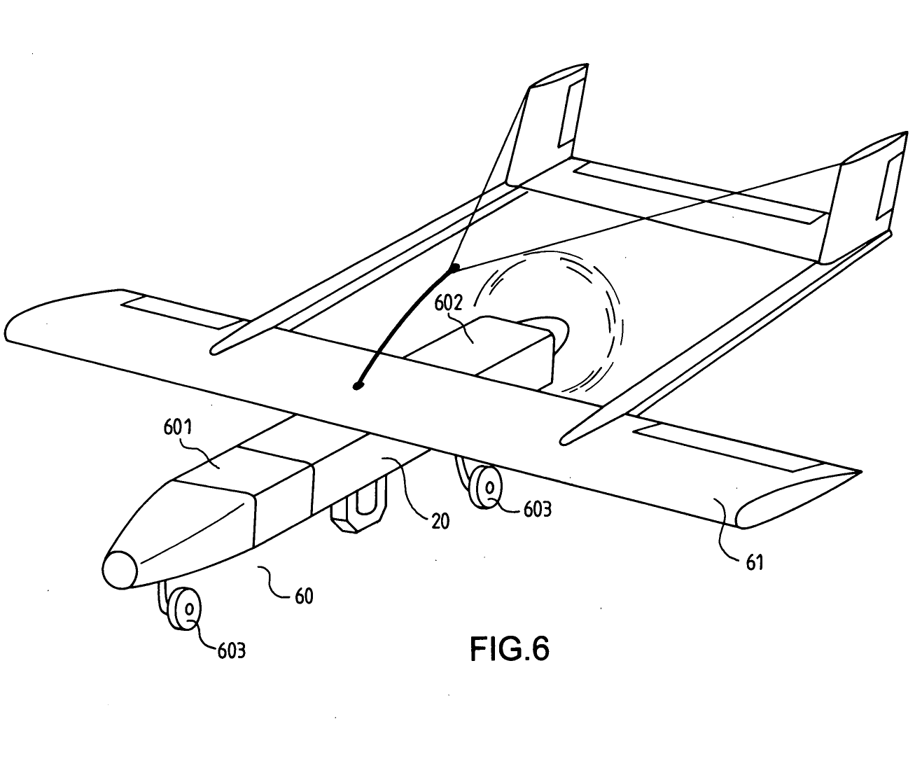

FIG. 6 represents a drone obtained with an onboard optronics system 60 of the type of that described in FIG. 5B. In this example, the central module 20 has connected to it two lateral modules 601, 602, each including, in addition to functions for transmitting data to the ground and recording data, etc., a landing gear 603. The rear lateral module 602 is also equipped in this example with an engine for propelling the drone. Thus, in this example, all that is needed to construct the final drone is to interface the wings 61 with the optronics system 60.

The examples of the onboard optronics system described above are not limiting. The advantages of this new modular architecture design are manifold. In particular it additionally allows for a central positioning of the center of gravity and a weight saving compared to the traditional pod architecture, by the reduced weight of the additional modules that are not involved in maintaining the stiffness of the optronic module. The applicant has shown that, with such a structure, the drag is reduced because it no longer presents a pointed half-sphere at the front of the pod for aerodynamic flow. The aerodynamic heating levels are lower than in a traditional structure because the surfaces at total temperature are fewer, in particular at sensor level. The environmental vibration levels can also be strongly reduced for the design of the subassemblies through an appropriate centering of the gyro-stabilized part in relation to the carrier, through a good mechanical aspect in relation to the points of attachment to the carrier. Radar discretion is increased compared to a “sphere” type architecture through the facility to retract the following cowl. Finally, because of its modular structure, it is possible with a given central module to construct a large number of different optronics systems for the different applications, so achieving reduced series production and development costs. Moreover, wide-ranging upgradeability potential is provided, for the architecture, but also for the components themselves (in particular the laser), and the other functional assemblies (conditioning, recorder, etc.).

Thus, the invention also relates to a method of implementing a set of onboard optronics systems, each optronics system being suited to a given mission, comprising the construction of a central module common to the optronics systems of the assembly based on given specifications of each mission, then, for each system, the construction of lateral modules specific to said mission. The designer of this new generation onboard optronics system according to the invention will define, initially, the central module forming a section, designed to receive the optronics elements and the target line orientation and stabilization mechanism, and which will be a common central module of a set or ‘kit’ of different onboard optronics systems. For this, he will define a set of missions, such as reconnaissance, laser guided weapon, navigation, active imaging, etc. and for each, specifications in terms of range, stabilization, optronics elements needed (visible spectrum camera, infrared camera, laser, etc.). This first step will enable him to dimension the central module common to the kit of systems suited to each of the missions. This central module will have in particular an input aperture, a stabilization quality, a harmonization, a target line displacement that is given according to said specifications. Then, the designer can define the lateral modules suited to each of the missions, such as a temperature conditioning module, a module for recording data and/or transmitting data to the ground, a landing gear for the drone kit, etc.

1-18. (canceled)

19. An onboard modular optronics system, comprising:
at least two optronics elements having a target line that can be addressed in a given space,
a target line orientation and stabilization mechanism;
a mechanical structure designed to be the interface with a carrier;
a module forming a section with three interfaces, including said interface with the carrier and two lateral interfaces that can receive a lateral module,
a following cowl in the form of a sphere with porthole that is transparent in a spectral band of the optronics system, and mounted in such a way as to be mobile relative-bearing-wise on the module forming a section, the optronics elements and the target line orientation and stabilization mechanism being directly incorporated in the module forming a section, wherein an optronics element is a camera, another optronics element is a laser source mounted on the outside of the following cowl in a space of the module forming a section, accessible through a hatch formed in said module.

20. The optronics system as claimed in claim 19, that is upgradeable.

21. The optronics system as claimed in claim 19, wherein the following cowl is retractable.

22. The optronics system as claimed in claim 19, wherein the target line orientation and stabilization mechanism is mounted directly in the following cowl.

23. The optronics system as claimed in claim 19, wherein the target line orientation and stabilization mechanism is fixed on a platform suspended in the following cowl.

24. The optronics system as claimed in claim 19, wherein each target line is defined by one or more optronics elements of given spectral wavebands, each porthole in the following cowl is suited to said spectral bands.

25. The optronics system as claimed in claim 19, wherein in addition to the laser source, other optronics elements are outside the following cowl.

26. The optronics system as claimed in claim 25, wherein the optronics elements outside the following cowl are mounted on a platform suspended in the following cowl.

27. The optronics system as claimed in claim 19, in which said lateral interfaces that can receive other modules are mechanical and/or electrical and/or hydraulic interfaces.

28. The optronics system as claimed in claim 27, equipped with two lateral modules mounted on said lateral interfaces, at least one of said modules being a fairing to optimize the aerodynamic shape of the optronics system.

29. The optronics system as claimed in claim 27, equipped with two lateral modules mounted on said lateral interfaces, at least one of said modules being an environment control module for cooling the system.

30. The optronics system as claimed in claim 27, equipped with two lateral modules mounted on said lateral interfaces, at least one of said modules being a module for transmitting information to the ground.

31. The optronics system as claimed in claim 27, equipped with two lateral modules mounted on said lateral interfaces, at least one of said modules being a module for recording data.

32. The optronics system as claimed in claim 27, equipped with two lateral modules mounted on said lateral interfaces, at least one of said modules comprising an optronics element.

33. The optronics system as claimed in claim 27, designed to be onboard a drone, equipped with two lateral modules mounted on said lateral interfaces, at least one of said modules comprising a landing gear.

34. A drone equipped with an optronics system as claimed in claim 27.

35. A fuel tank designed to be onboard a carrier and incorporating in its central part an optronics system as claimed in claim 19, the mechanical structure being reduced to said central module forming a section.

36. A method of implementing a set of onboard optronics systems as claimed in claim 19, each optronics system being suited to a given mission, comprising the construction of a central module common to the optronics systems of the assembly based on given specifications of each of said missions, then, for each system, the construction of lateral modules specific to said mission.
